(19) United States
(12) Patent Application Publication
(10) Pub. No.: US 2014/0075841 A1
(43) Pub. Date: Mar. 20, 2014

(54) HYDROPONIC GROWING SYSTEM

(71) Applicant: BRAD DEGRAFF, Temecula, CA (US)

(72) Inventor: BRAD DEGRAFF, Temecula, CA (US)

(21) Appl. No.: 13/623,053

(22) Filed: Sep. 19, 2012

(51) Int. Cl. A01G 31/02

(52) U.S. Cl. CPC A01G 31/02
USPC 47/62 A; 47/62 R

(57) ABSTRACT

A new hydroponic growing system that incorporates a non-woven soft-sided fabric container housed and/or supported within a plant reservoir container is proposed. The present invention includes a main reservoir that is in communication with multiple plant reservoir containers connected each other. The predetermined intervals are set and controlled by the controller at the main reservoir to fill and drain the plant reservoir containers. With an aid of use of a soft-sided fabric container made of fine mesh-like non-woven material, the present invention minimizes the medium from travelling with nutrients when the pump is activated to drain the bucket. In addition, the present invention includes aeration devices, such as an air tube, creating a vent which minimizes water resistance when draining the bucket. Variations on the type or material for the soft-sided fabric container, and various methods for supporting and suspending the soft-sided fabric containers can be considered.

### RELATED APPLICATION

This application claims the benefit of priority to U.S. Provisional Patent Application Ser. No. 61/536,490, entitled “Hydroponic Growing System” filed on Sep. 19, 2011, and currently co-pending.

### FIELD OF THE INVENTION

The present invention pertains generally to devices for a hydroponic growing system for plants. The present invention is more particularly, though not exclusively, useful as adopting a soft-sided fabric container made of non-woven material that is housed and/or supported within a plant reservoir container in a hydroponic growing system. By adopting a non-woven material, the present invention minimizes the soil erosion or medium loss generally developed from travelling with liquid nutrients when the pump is activated to draw the fluid between plant reservoir containers and a main reservoir.

### BACKGROUND OF THE INVENTION

Hydroponics is a method of growing plants using mineral nutrient solutions in water, without an aid of soil. Terrestrial plants may be grown with their roots in the mineral nutrient solution or in an inert medium, such as rockwool, perlite, gravel, mineral wool, or coconut husk. Plants absorb essential mineral nutrients, such as inorganic ions, from water. In natural conditions, the soil acts as a mineral nutrient reservoir, but, it has been known that the soil itself is not essential to the plant growth. When the required mineral nutrients are artificially introduced into a plant's water supply, the soil is no longer required for the plant to thrive. Since almost any type of terrestrial plants can grow within hydroponic plant-growing systems, hydroponic plant-growing systems have been widely used.

One of the main advantages related to hydroponic growing systems is that the roots of the plant have constant access to oxygen and that the plants have access to as much or as little water as they need. Hydroponics prevents over or under watering from occurring since a large amount of water is made available to the plant and any water not used is periodically drained away, recirculated, or actively aerated, eliminating anoxic conditions which drown root systems in soil. Thus, through hydroponics, it is possible to control the nutrition levels in their entirety and the controlled nutrition levels do not release any nutrition pollution into the environment. In addition, due to the container's mobility, pests and diseases in the plants are easier to remove when the plants are grown in hydroponic growing systems than when they are in soil.

In its simplest form, the typical hydroponic system includes a floodable tray above a reservoir of nutrient solution. Either the tray is filled with growing medium (clay granules being the most common) and planted directly, or pots filled with growing medium, stand in the tray. At regular intervals, a simple timer causes a pump to fill the upper tray with nutrient solution, after which the solution drains back down into the reservoir. This periodic flooding keeps the medium regularly flushed with nutrients and air. Once the upper tray fills past the drain stop, it begins recirculating the water until the pump is turned off, and the water in the upper tray drains back into the reservoirs.

Despite the numerous benefits of the currently available ebb and flow type hydroponic system, each of them is plagued by the medium within the containers and the medium often passes through the holes at the bottom of the container. When the containers are flooded from the bottom and then drained back out, the medium is easily mixed with all the nutrients within water. This results in the loss of the mediums, and this often causes the water lines to become clogged.

Currently existing hydroponic systems comprise a plastic “bucket within a bucket” when used as the top pot, and this is a major problem as the fabric container is not rigid enough to rest on top plant container reservoirs as they do with pre-existing systems. Thus, even with the use of the fabric container in an ebb and flow type hydroponic system, without any support system for the fabric container, the fabric container would rest on the bottom of the plant reservoir container. This is also problematic since the fabric container would be resting in the remaining liquid nutrients that the drain pump could not remove.

Such an ebb and flow type hydroponic system is functioned by gravity and therefore, the controller bucket is set at the same level as the plant reservoir containers. Without any support system for the fabric container, the lowest magnetic float switch in the controller bucket only allows for most of the nutrient to be pumped back into the reservoir. Due to the incapability of placing the magnetic float switches for the drain pump mechanism below the base of the controller bucket,there will be left over liquid nutrients inside the plant container reservoirs.

Therefore, currently existing hydroponic systems include an inevitable portion of roughly 10 percent of the nutrient that remains in the bottom plant containers after the fill/drain cycle. Without the support system, the fabric container will be in standing water. This accordingly results in the suffocation of roots of the plant, preventing or disturbing the roots from growing. In addition, the drainage holes in the top container of the currently existing hydroponic systems are rather large and the users have to use the growing mediums that do not erode or pass through those drainage holes. Mediums that are fine granulated or miniscule would easily travel back with the nutrients during the drain process from the plant reservoir to the main reservoir. Thus, the currently existing hydroponic systems have forced the plant-growers to use larger medium types, such as rockwool or clay pebbles (hydroton). It has been known that roots in standing water or “stagnant” water will severely limit or stop root growth.

In addition, the drainage holes in the top container of the currently existing hydroponic systems are rather large, forcing the user to only use growing mediums that do not erode or pass through those drainage holes. Mediums that are fine granulated, or miniscule would easily travel back with nutrients during the drain process from the plant reservoir to the main reservoir. Thus, the currently existing hydroponic systems have forced the growers to use mainly larger medium types such as rockwool or clay pebbles (hydroton).

In light of the above, it would be advantageous to provide a new ebb and flow type hydroponic system that can incorporate a variety of medium types. It will be advantageous to provide a container that minimizes the medium from travelling with nutrients when the fluid between the plant reservoir containers and the main reservoir is drained. It is further advantageous to provide a hydroponic system that is relatively cost effective to manufacture, and affordable to use and maintain.

### SUMMARY OF THE INVENTION

The present invention proposes a new hydroponic growing system that incorporates a soft-sided fabric container made of non-woven material that is housed and/or supported within a plant reservoir container. The system in this invention includes a main reservoir that is in communication with a number of plant reservoirs. Through the function of filtering of the medium by the characteristics of the permeable non-woven material that does not have “drainage holes,” this invention minimizes the medium from eroding and travelling with nutrients when the pump is activated to draw the fluid from the plant reservoir containers and to the main reservoir. By providing a support and/or suspension system for the soft-sided fabric container, the present invention allows support and suspension of the soft-sided bag to be supported above a level of the remaining nutrients. The present invention also provides the plant-growers with various alternatives for their own choices of the medium and solves the erosion problem, rendering fine/granulated mediums, such as soil, perlite, vermiculite, and coco coir, available to use. In addition, the present invention may include aeration devices, such as air tubes, which create a vent minimizing water resistance when draining the bucket. The present invention further includes variations on the soft-sided fabric containers, and its support and suspension methods.

### BRIEF DESCRIPTION OF THE DRAWING

The nature, objects, and advantages of the present invention will become more apparent to those skilled in the art after considering the following detailed description in connection with the accompanying drawings, in which like reference numerals designate like parts throughout, and wherein:

FIG. 1 is a diagrammatic view of the hydroponic growing system comprising a main reservoir which is connected to the controller with “fill” and “drain” switches and multiple plant reservoir containers each of which consists of a bucket, a soft-sided fabric container, a spacer, and a fluid connection port for the inlet and outlet of the fluid;

FIG. 2 is a more detailed diagrammatic view of an individual plant reservoir container comprising a bucket, a soft-sided fabric container, a spacer, and a fluid connection port;

FIG. 3 is a top view of a ring, as an alternative means of connecting the soft-sided fabric container to the bucket;

FIG. 4 is a diagrammatic view of a hydroponic growing system comprising a soft-sided fabric container connected to the bucket through the ring;

FIG. 5 is a cross-sectional view of a hydroponic growing system equipped with a soft-sided fabric container connected to the bucket through the ring, combined with connectors to it, and with suggested dimensions for the entire system illustrated;

FIG. 6A is a diagrammatic front view of an alternative embodiment of the present invention having a square type soft-sided fabric container placed inside a square bucket in preparation for incorporation with square bucket, showing directional axis for reference, presently showing E-W orientation;

FIG. 6B is a diagrammatic side view of an alternative embodiment of the present invention having the square type soft-sided fabric container folded down, sewn, riveted creating a loop facilitating incorporation into a square bucket, presently shown according to the N-S axis of FIG. 6A;

FIG. 6C is a diagrammatic side view of the square bucket incorporated with a square type soft-sided fabric container having clips to secure the soft sided fabric container to square bucket showing loops created by, and shown according to the E-W orientation of FIG. 6A;

FIG. 7 is a top view of a square bucket equipped with a square type soft-sided fabric container with 4 holes around the bucket;

FIG. 8 is a cross-sectional view of a square bucket equipped with a soft-sided fabric container, which is connected to the bucket through the holes and hooks and/or clips;

FIG. 9 is a cross-sectional view of an illustration of a spacer comprising a plurality of the slightly tapered protrusions placed on the top of the cylinder type bottom of the spacer that should be inserted into the bucket equipped with a soft-sided fabric container, to prevent the roots in the soft-sided fabric container from being in standing water or “stagnant” water;

FIG. 10 is a cross-sectional view of a hydroponic growing system equipped with a oft-sided fabric container supported and/or suspended through a support system, and a spacer allowing an adequate level of oxygen to the plant in the soft-sided fabric container without resulting in suffocation of roots of the plant;

FIG. 11 is a perspective view of an alternative embodiment of a hydroponic growing system equipped with a soft-sided fabric container supported and/or suspended through a support system, and an air tube comprising multiple holes where the air tube creates a vent minimizing or preventing water resistance when draining the bucket;

FIG. 12 is a cross-sectional view of a hydroponic growing system equipped with a soft-sided fabric container and an air tube comprising multiple holes and an open end, such that a vent is created to pass the air to drain the bucket; and

FIG. 13 is a top view of an alternative embodiment of the present invention comprising a bucket equipped with a drainer with supports underneath, allowing an adequate level of oxygen to the plant in the soft-sided fabric container by placing the soft-sided fabric container on the drainer.

### DETAILED DESCRIPTION OF A PREFERRED EMBODIMENT

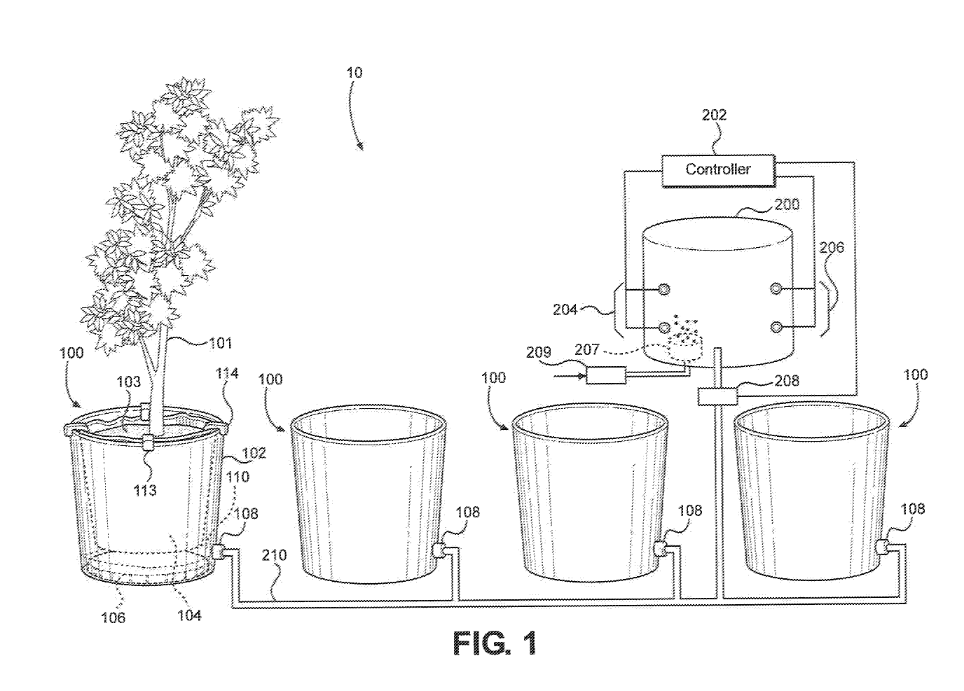

Referring initially to FIG. 1, a hydroponic growing system in the present invention is generally designated 10, and includes multiple plant reservoir containers 100 and a main reservoir 200 connected to the controller 202 is illustrated. The individual plant reservoir container 100 is connected to the main reservoir 200 and to the other plant reservoir containers 100 through the connection port 108 on each plant reservoir container 100 and the connection pipeline 210. The connection ports 108 are used both for the inlet and outlet of the fluid from the main reservoir 200 to the plant reservoir containers 100. According to predetermined intervals controlled by a float and timing mechanism set up by the controller 202, the “fill” switches 204 are activated through the pump 208 and thus, the plant reservoir containers 100 are flooded to a specific water level 110 to immerse the soft-sided fabric container 104 to supply water and other nutrients to the roots of the plant 101. Following a delay, the system reverses and draws the fluid from the plant reservoir containers 100 back to the main reservoir 200, as the “drain” switches 206 are activated through the pump 208, controlled by the controller 202.

The soft-sided fabric container 104 adopted, in this invention is made of a non-woven material, such as polypropylene, that has the rigidity to hold its shape and can even support large trees. These fabric containers exhibit the unique ability to promote superior root systems, and a better response of the plants in commercial settings. The soft-sided fabric container 104 serves as an aeration container which uniquely air-prunes and enhances a plants root structure and has a sufficient rigidity to hold its shape and even support large trees. A highly branched and fibrous root structure is critical in growing a better plant, with more flowers and fruits, and more resistance to insects and diseases. In addition, it is known that the roots grown in the soft-sided fabric containers are less stressed during a hot summer season because the soft-sided fabric containers generally stay much cooler than the other containers for plants. Thus, the soft-sided fabric container 104 made of non-woven material is specifically selected in the present invention since the non-woven, polypropylene material serves as a fine particle filter and thereby minimizes travelling of the medium 103 together with nutrients when the pump 208 is activated to fill or drain the fluid from main reservoir 200 to the plant reservoir containers 100.

Each individual plant reservoir container 100 incorporates a soft-sided fabric container 104 that is housed and/or supported within the plant reservoir container 100, and in a preferred embodiment, this soft-sided fabric container 104 is suspended within the bucket 102, by means of the clips 113 and/or the hooks 114. For a desired space between the bottom of the soft-sided fabric container 104 and the bottom of the bucket 102, considering a specifically ideal water level 110 controlled and predetermined by the controller 202, a spacer 106 may be used. With an aid of the spacer 106, the roots of the plant would have constant access to oxygen and that the plants have an access to as much or as little water as they need, depending on the water level 110 within the container.

In a preferred embodiment of the present invention, an aerator 207 is provided and introduces microfine air bubbles into the solution contained within the main reservoir. A primary purpose of the introduction of air into the solution within the main reservoir is to maintain a healthy solution for optimized growing within the hydroponic system. Aerator 207 includes an air vent that receives air from an air pump 209, and forces air into the aerator chamber located within the main reservoir 200 where the supplied air is agitated to create fine air bubbles that then dissipate within the fluid within the main reservoir 200.

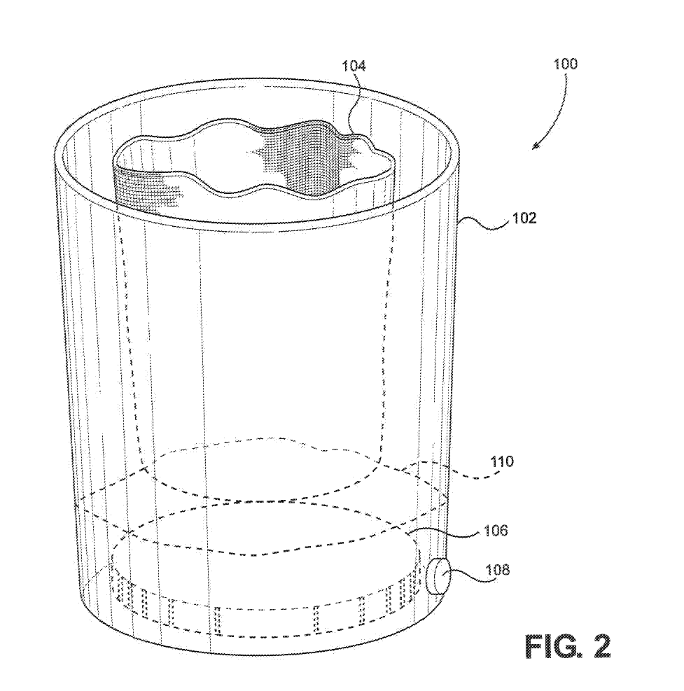

FIG. 2 is an illustration of an individual plant reservoir container 100. As described in FIG. 1, a soft-sided fabric container 104 is housed and/or supported within a plant reservoir container 100, and this soft-sided fabric container 104 is suspended to the bucket 102, by several means, such as clips and/or hooks, or some other means that will be discussed later. As described above, a spacer 106 may be used to provide a support to the bottom of a soft-sided fabric container 104 and also to maintain a desired distance between the bottom of the soft-sided fabric container 104 and the bottom of the bucket 102 for an adequate level of access to oxygen.

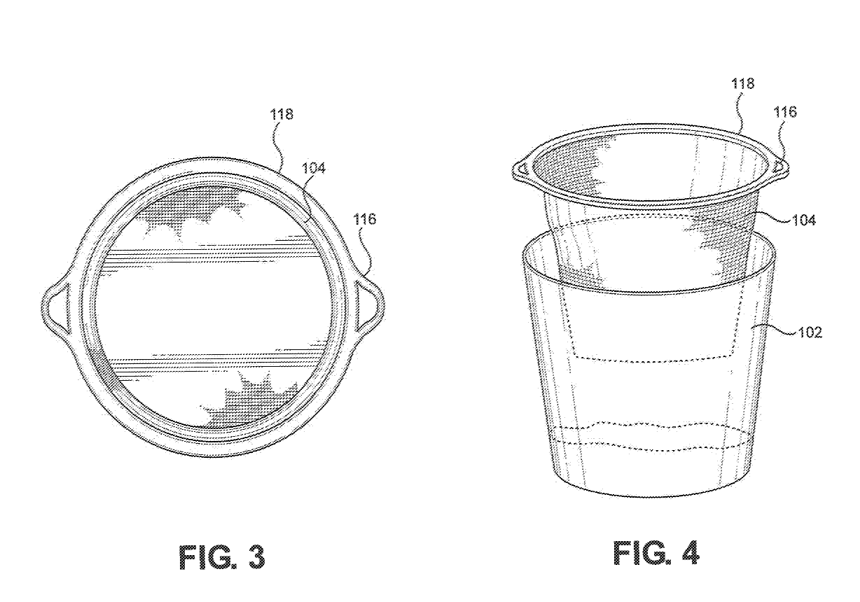

Referring now to FIG. 3, a ring 118 is shown as one of the means of connecting a soft-sided fabric container 104 to the bucket 102. In a preferred embodiment, a ring 118 contains handles 116 for an easier handling and attachment. As illustrated in FIG. 4, a ring 118 is formed to a soft-sided fabric container 104 and is sized to be slightly larger in diameter than the bucket 102 such that by positioning the ring 118 above the bucket 102, the soft-sided fabric container 104 is fully positioned within the bucket 102 and available for saturation through the flooding of the bucket 102.

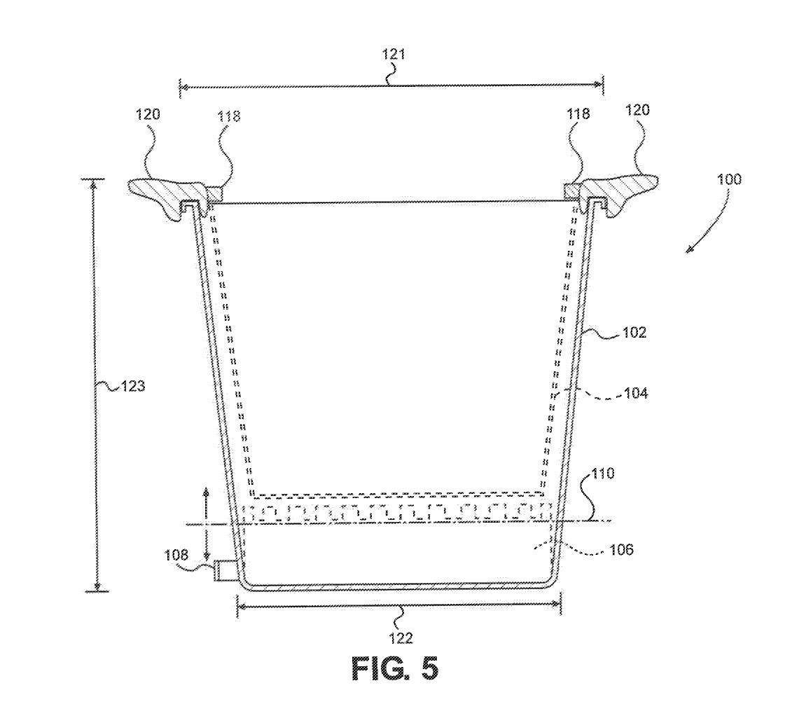

FIG. 5 depicts a cross-sectional view of a hydroponic growing system of an alternative embodiment of the present invention equipped with a soft-sided fabric container 104 incorporated into the bucket 102 through the ring 118, attached with the connectors 120 to fix the soft-sided fabric container 104 to the bucket 102. The connectors 120 attached to the handles 116 (shown in FIGS. 3 and 4) on the ring 118 suspend the soft-sided fabric container 104. In the present invention, variations on the soft-sided fabric container 104 and the connectors 120 including a molded container insert and several suspension approaches, may be considered. For instance, a variety of over-the-rim connectors and various types of a soft-sided fabric container formed with apertures to receive hooks placed over the rim of bucket 102 are contemplated in the present invention.

FIG. 5 further illustrates one of the suggested specifications for a preferred embodiment of the plant reservoir container 100 incorporated with a soft-sided fabric container 104 which is suspended by the ring 118 and the connectors 120. The diameter 121 for the topside of the bucket 102 may be 36 cm, and the diameter 122 of the bottom of the bucket 102 may be 23 cm. The bucket 102 can be, in a preferred embodiment, 29.5 cm in its height 123. While these dimensions are representative of a preferred embodiment, it is to be understood that these dimensions provided in no way limit the scope of the present invention. Indeed, the specific dimensions of the present invention may vary depending on the volume of medium, the size of the plants being grown, and the volume of water utilized.

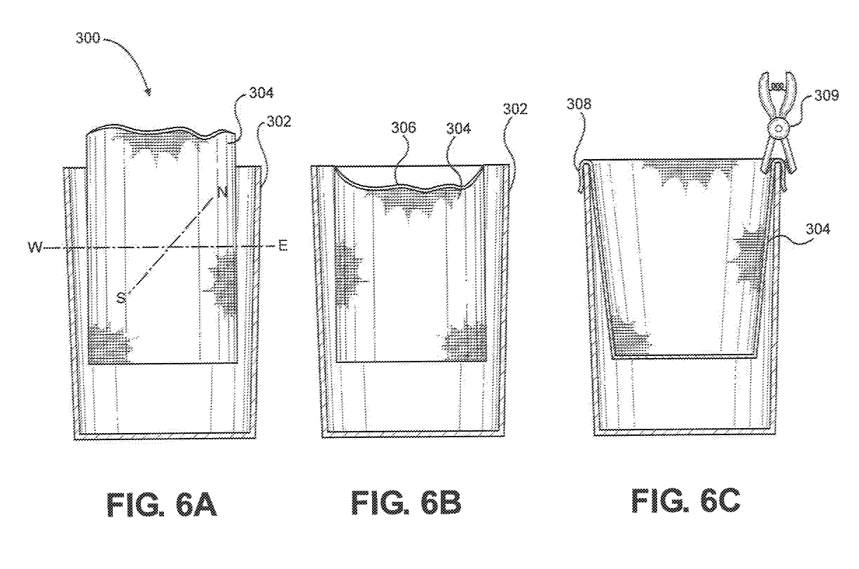

Referring now to FIGS. 6A, 6B, and 6C, as an alternative embodiment, the present invention adopts a hydroponic growing system comprising a square bucket and a square type soft-sided fabric container. For instance, FIGS. 6A, 6B, and 6C illustrates a series of side views for the square type soft-sided fabric container 304 made of non-woven material, which would be folded, sewn, riveted, and attached to create a loop for the suspension of the soft-sided fabric container 304 to the square bucket 302. FIG. 6A depicts a square type soft-sided fabric container 304 which is ready to be incorporated into the square bucket 302. FIG. 6B illustrates a side view of the square bucket 302 incorporated with a square type soft-sided fabric container 304, shown according to the axis N-S on FIG. 6A. Fabric end 306 is folded down, sewn, riveted, and attached to the wall of the square bucket 302. FIG. 6C depicts a side view of the square bucket 302 incorporated with a square type soft-sided fabric container 304, shown according to the axis E-W on FIG. 6A. As shown in FIG. 6C, the loops 308 are created when the fabric end 306 is folded down, sewn, riveted, and attached to the wall of the square bucket 302. The loops 308 will be used for suspension of the square type soft-sided fabric container 304 to the square bucket 302, using hooks and/or clips and holes. In an alternative embodiment, a plurality of clips 309 may be used to secure the soft-sided fabric container 304 to bucket 302. Clips 309, in a preferred embodiment, may be spring-loaded to allow for the easy positioning and securing of the soft-sided fabric container in the bucket 302, and to allow for easy removal of the container 302.

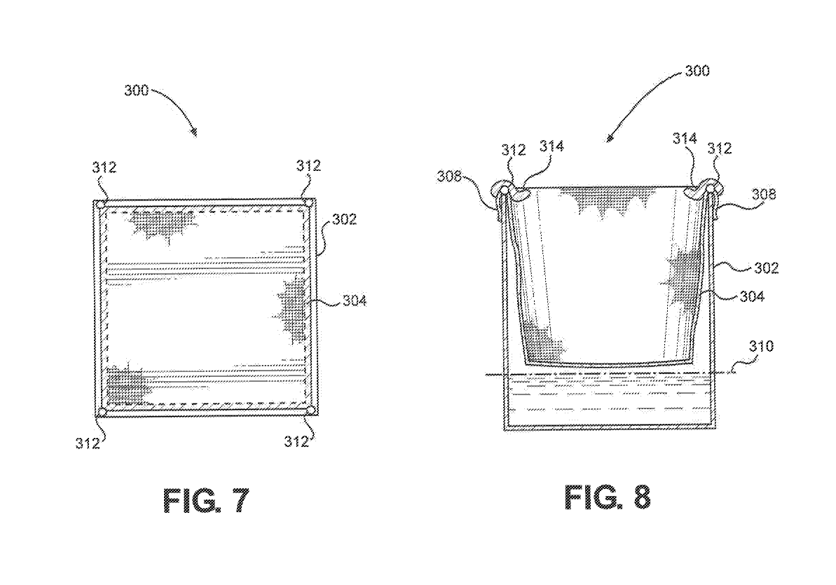

FIG. 7 depicts a top view of a square bucket 302 equipped with a square shaped soft-sided fabric container 304 formed with four (4) through-holes 312 around the bucket 302. As a suspension method for the soft-sided fabric container, hooks and/or clips can be used to connect the square shaped soft-sided fabric container 304, through the holes 312, to the square bucket 302.

FIG. 8 illustrates a cross-sectional view of an alternative embodiment 300 of a hydroponic growing system equipped with a square type soft-sided fabric container 304 incorporated into the square bucket 302. The loops 308 created when the square type soft-sided fabric container 304 is folded, sewn, riveted and attached to the wall of the square bucket 302, will be used for suspension of the square shaped soft-sided fabric container 304 to the square bucket 302, through hooks 314 and/or clips and holes 312. In the present invention, variations on the square type soft-sided fabric container 304, holes 312 and hooks 314 and/or clips, and several other suspension approaches may be adopted without departing from the spirit of the present invention.

The square plant reservoir container 300 is flooded to a specific water level 310 to immerse the square type soft-sided fabric container 304 to supply water and other nutrients to the roots of the plant. As shown, water level 310 may be adjusted up or down to flood the soft-sided fabric container 304 when desired.

As described herein, the soft-sided fabric containers are made from a synthetic non-woven polymer material that provides for a free passage for water and nutrients dissolved or suspended in the supply water. Accordingly, as the reservoir containers are flooded, the water carrying nutrients rises and floods the roots placed within the soft-sided container. Due to the fine mesh-like construction of the non-woven polymer soft-sided container, no loss or erosion of the media, such as soil or other growing substrates, occurs when the water is drained from the soft-sided container.

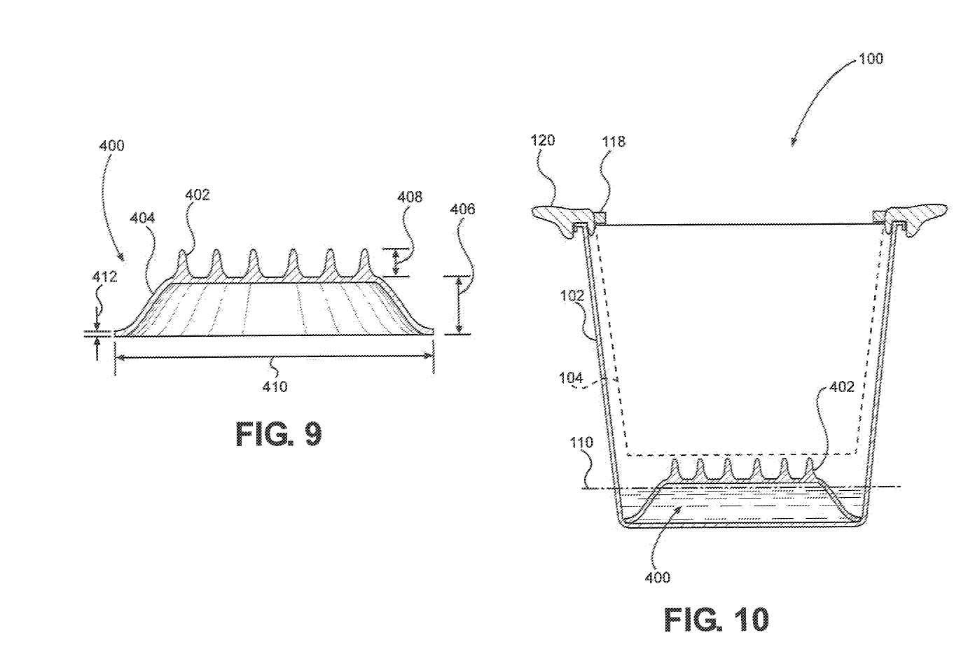

FIG. 9 depicts a cross-sectional view of an example of an alternative spacer 400 that is inserted into the bucket equipped with a soft-sided fabric container, to prevent the roots in the soft-sided fabric container from being in standing water or “stagnant” water. As a specific illustration of the spacer 400, a plurality of slightly tapered protrusions 402 attached on the top of the cylinder-shaped bottom 404 having a diameter 410 of the spacer 400 is shown. The plurality of protrusions 402 are specifically adopted for the roots of the plant to have a constant access to oxygen by maintaining an adequate distance and space between the bottom of the bucket and the soft-sided fabric container. With an aid of the plurality of the tapered protrusions 402, and the height 406 of the bottom 404, the roots of the plant within the soft-sided fabric container will always be placed above a level of the remaining nutrients in water. By adopting this type of a spacer 400, problems of limited or stopped growth of the roots resulting from the roots in standing water or “stagnant” water will be resolved.

FIG. 9 also illustrates one of the suggested specifications for the spacer 400. The height 408 of the protrusions may be ⅞″ the diameter 410 of the bottom 404 of the cylinder may be 10″ in its diameter, and the thickness 412 of the material adopted for the spacer 400 can be 3/16″, for example.

FIG. 10 depicts a cross-sectional view of a hydroponic growing system 100 equipped with a soft-sided fabric container 104 supported and/or suspended through a support system, and an alternative spacer 400 allowing an adequate level of oxygen to the plant in the soft-sided fabric container without resulting in a suffocation of the roots of the plant.

FIG. 10 also illustrates another suggested specification for the embodiment of the plant reservoir container 100 incorporated with a soft-sided fabric container 104 which is suspended by the ring 118 and the connectors 120, and a spacer 400 comprising a plurality of slightly tapered protrusions 402 attached on the top of the cylinder-shaped bottom of the spacer 400. The diameter for the bottom of the bucket 102 may be 8¾″, and the bucket 102 can be suggested to be 11½″ in its height. While these dimensions are suggested for this embodiment, it is to be understood that these dimensions provided in no way limit the scope of the present invention. Indeed, the specific dimensions of the present invention may vary depending on the volume of medium, the size of the plants being grown, and the volume of water utilized.

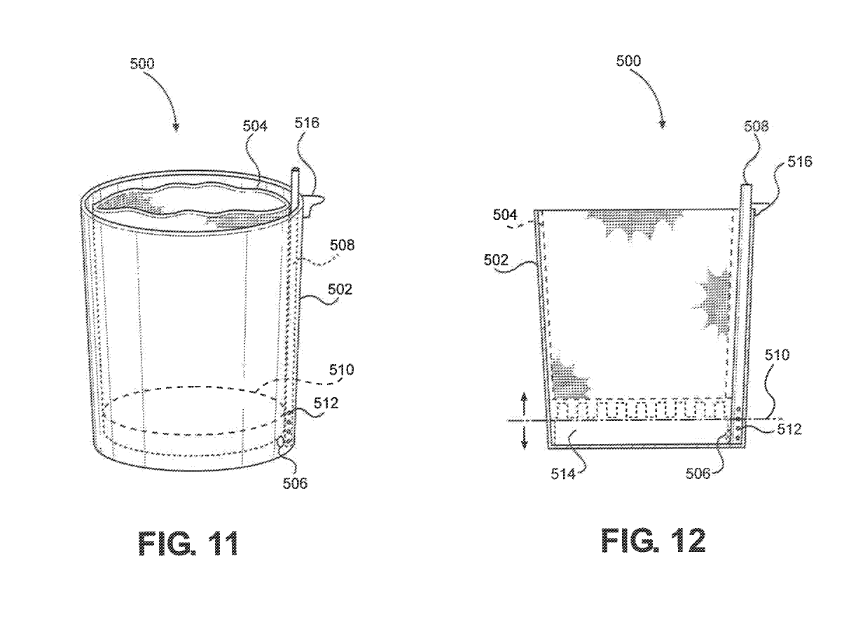

As another alternative embodiment of the present invention in use, FIG. 11 depicts a perspective view of a hydroponic growing system equipped with a soft-sided fabric container 504 supported and/or suspended through a support system 516, and an air tube 508 comprising multiple holes 512 and an open end 506, where the air tube 508 creates a vent minimizing or preventing water resistance when draining the bucket 502. When a non-woven soft-sided fabric container 504 is wet, the soft-sided fabric container 504 containing medium swells to the walls of bucket 502, and due to such moisture, this swollen soft-side fabric container creates a vacuum when draining. A non-woven material used for the soft-sided fabric container 504 may become substantially non-permeable to air when it gets wet. When a non-woven soft-sided fabric container 504 creates a vacuum and is sealed due to the moisture, a great amount of water resistance is generated within the soft-sided fabric container 504 and it becomes hard to drain the bucket 502. When an air tube 508 comprising multiple holes 512 is used, the air tube 508 creates a vent such that there can be little or no water resistance when draining the bucket 502. By providing air through the air tube 508, the bucket 502 will then more easily be drained.

FIG. 12 depicts a cross-sectional view of a hydroponic growing system equipped with a soft-sided fabric container 504, a spacer 514, and an air tube 508 comprising multiple holes 512 and an open end 506 of the tube 508. With an aid of a spacer 514, even in case the soft-sided fabric container 504 with medium swells, it sits on the spacer 514, still above the water level 510, As discussed above, with an aid of the use of an air tube 508 comprising multiple holes 512, a vent is created between the open atmosphere and the region within the bucket and below the soft-sided fabric container so that there can be little or no water resistance when draining the bucket 502 through drain 506.

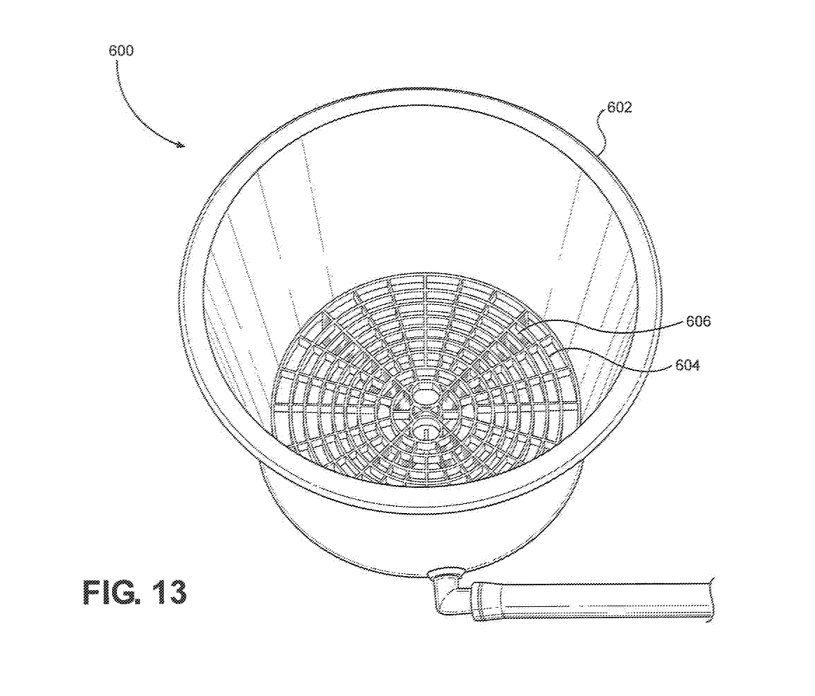

Now referring to FIG. 13, a top view of an alternative embodiment 600 of the present invention includes a bucket equipped with a drain screen. As shown in FIG. 13, bucket 602 of the hydroponic growing system is equipped with a drain screen 604 formed with supports 606 underneath the drain screen 604. The soft-sided fabric container will be placed on the top of the drain screen 604, to provide an adequate level of oxygen to the plant in the soft-sided fabric container, by maintaining an appropriate distance between the bottom of the soft-sided fabric container and the bottom of the bucket 602. With an aid of the supports 606 underneath the drain screen 604, the roots of the plant within the soft-sided fabric container will always be placed above a level of the remaining nutrients in water. Therefore, the roots of the plant will not be in standing water or “stagnant” water.

While there have been shown what are presently considered to be preferred embodiments of the present invention, it will be apparent to those skilled in the art that various changes and modifications can be made herein without departing from the scope and spirit of the invention.

I claim:

1. A hydroponic growing system for plants, comprising:
a main reservoir having a fill switch and a drain switch;
at least one plant reservoir container comprising a bucket and having a soft-sided fabric container at least partially within said bucket;
a controller in electrical connection with said fill switch and said drain switch;
a pump in fluid communication with said main reservoir and said plant reservoir container, and in electrical connection with said controller wherein said pump is responsive to said controller to pass fluid from said main reservoir to said plant reservoir container.

2. The hydroponic growing system of claim 1, further comprising a spacer sized to be received in said plant reservoir container and beneath said soft-sided fabric container.

3. The hydroponic growing system of claim 2, wherein said spacer is configured to prevent said soft-sided fabric container from contacting the bottom of said plant reservoir container.

4. The hydroponic growing system of claim 2, wherein said spacer further comprises a cylinder-shaped bottom having a plurality of slightly tapered protrusions extending upwards from said bottom.

5. The hydroponic growing system of claim 2, wherein said spacer further comprises: a drain screen; and supports beneath said drain screen to maintain an air gap between said bottom of said reservoir and said soft-sided fabric container.

6. The hydroponic growing system of claim 2, wherein said spacer is configured to prevent said soft-sided fabric container from contacting the bottom of said plant reservoir container.

7. The hydroponic growing system of claim 1, further comprising an aerator in said main reservoir and configured to introduce air into a fluid within said reservoir.

8. The hydroponic growing system of claim 1 wherein the controller at the said main reservoir sets and controls the predetermined intervals to fill and drain the said plant reservoir containers.

9. The hydroponic growing system of claim 1 further comprises:
a connection port used both for the inlet and outlet of fluid from the said main reservoir; and
a connection pipeline extending between said main reservoir and said connection port of each plant reservoir container to connect the multiple plant reservoir containers each other.

10. The hydroponic growing system of claim 1 wherein said soft-sided fabric containers are made from a synthetic polymer material.

11. The hydroponic growing system of claim 1 wherein said soft-sided fabric container is porous and formed with a pore size less than 0.05″ to have a porosity for liquids, yet minimize loss or erosion of the media.

12. The hydroponic growing system of claim 1 wherein said soft-sided fabric container is porous and formed with a pore size less than 0.02″ to have a porosity for liquids, yet minimize loss or erosion of the media.

13. The hydroponic growing system of claim 1 further comprising a plurality of clips to secure said soft-sided fabric container in said plant reservoir container.

14. The hydroponic growing system of claim 1 further comprising a plurality of hooks to secure said soft-sided fabric container in said plant reservoir container.

15. The hydroponic growing system of claim 1 further comprising a ring attached to said soft-sided fabric container and sized to sit atop said plant reservoir container to suspend said soft-sided fabric container within said plant reservoir container.

16. The hydroponic growing system of claim 1 wherein said plant reservoir container is square, and said soft-sided fabric container is square and sized to be received within and suspended within said plant reservoir container.

17. The hydroponic growing system of claim 1 wherein said soft-sided fabric container is fixedly attached to said plant reservoir container using a means for attachment.

18. The hydroponic growing system of claim 1 further comprising an air tube having a lower end and an upper end and formed with a lumen, said air tube positioned within said plant reservoir container and extending from the bottom of said container upwards past said soft-sided fabric container.

19. The hydroponic growing system of claim 19 wherein said air tube is formed with a plurality of air holes adjacent said lower end.
